(19) United States
(12) Patent Application Publication
(10) Pub. No.: US 2025/0166425 A1
(43) Pub. Date: May 22, 2025

(54) INFORMATION PROCESSING DEVICE

(71) Applicant: TOYOTA JIDOSHA KABUSHIKI KAISHA, Toyota-shi (JP)

(72) Inventors: Nao MATSUBARA, Toyota-shi (JP); Tomoyoshi UEKI, Toyota-shi (JP); Hiroshi YAMASAKI, Nagoya-shi (JP); Isao SATO, Nagoya-shi (JP)

(73) Assignee: TOYOTA JIDOSHA KABUSHIKI KAISHA, Toyota-shi (JP)

(21) Appl. No.: 18/915,361

(22) Filed: Oct. 15, 2024

(30) Foreign Application Priority Data
Nov. 20, 2023 (JP) 2023-196680

(51) Int. Cl. G07C 5/00; B60L 58/12; G07C 5/08

(52) U.S. Cl. CPC G07C 5/008; B60L 58/12; G07C 5/0808; G07C 5/0816

(57) ABSTRACT

The control unit of the information processing device acquires the accident information regarding the situation of the accident of the accident vehicle. The control unit of the information processing device uses the acquired accident information to identify a portion that can be used for a rebuild in which part or all of the components of the battery attached to the accident vehicle are reused. Then, the control unit of the information processing device outputs information about a part that can be used for rebuilding in the specified battery.

### CROSS-REFERENCE TO RELATED APPLICATION

This application claims priority to Japanese Patent Application No. 2023-196680 filed on Nov. 20, 2023, incorporated herein by reference in its entirety.

### BACKGROUND

### 1. Technical Field

The present disclosure relates to an information processing device.

### 2. Description of Related Art

Japanese Unexamined Patent Application Publication No. 2022-68613 (JP 2022-68613 A) discloses an information processing method. In the information processing method disclosed in JP 2022-68613 A, battery-related information relating to an in-vehicle battery is acquired from a battery database (DB). In the information processing method, the degree of deterioration of the battery is diagnosed according to the acquired battery-related information, and the diagnosed degree of deterioration of the battery is recorded in a diagnosis DB. Then, in the information processing method, the transaction price of the battery for which the degree of deterioration is diagnosed is presented using a calculation method that determines the relationship between the degree of deterioration of the battery and the transaction price.

### SUMMARY

An object of the present disclosure is to provide a technique that enables efficient reuse of a battery.

An aspect of the present disclosure provides an information processing device including
a control unit configured to: acquire accident information related to a status of an accident of an accident vehicle;
identify a portion of a battery attached to the accident vehicle that is usable in a rebuild in which some or all parts of the battery are reused, using the acquired accident information; and
output information about the identified portion of the battery that is usable in the rebuild.

According to the present disclosure, it is possible to enable efficient reuse of a battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a storage system;

FIG. 2 is a diagram illustrating an example of the arrangement of batteries in a vehicle;

FIG. 3 is a block diagram schematically illustrating an example of a functional configuration of a server;

FIG. 4 is a diagram illustrating an example of a table configuration of vehicle information stored in a vehicle information database;

FIG. 5 is a diagram illustrating an exemplary table configuration of correspondence information held in a correspondence information database; and

FIG. 6 is a flowchart of processing executed by the control unit.

### DETAILED DESCRIPTION OF EMBODIMENTS

It is assumed that a vehicle has an accident. In this case, the battery attached to the vehicle that caused the accident (hereinafter, sometimes referred to as “accident vehicle”) may be damaged due to the influence of the accident. As a result, the battery may not be able to be used for a rebuild that reuses some or all of the components due to damage. It is also envisioned that the use of such a damaged battery for rebuilding may cause a failure of a new battery with a failed component attached thereto. On the other hand, if all of the batteries of the accident vehicle are not used for rebuilding, efficient reuse of the batteries is suppressed. An information processing device according to the present disclosure solves such a problem.

The control unit of the information processing device according to the present disclosure acquires the accident information regarding the situation of the accident of the accident vehicle. The control unit of the information processing device uses the acquired accident information to identify a portion that can be used for rebuilding the battery attached to the accident vehicle. Then, the control unit outputs information about a portion of the battery that can be used for rebuilding.

As described above, the information processing device uses the accident information to identify a portion that can be used for rebuilding. As a result, a portion that can be used for the rebuild is used for the rebuild, even if the battery is attached to the accident vehicle. In this way, efficient reuse of the battery can be achieved.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

### System Overview

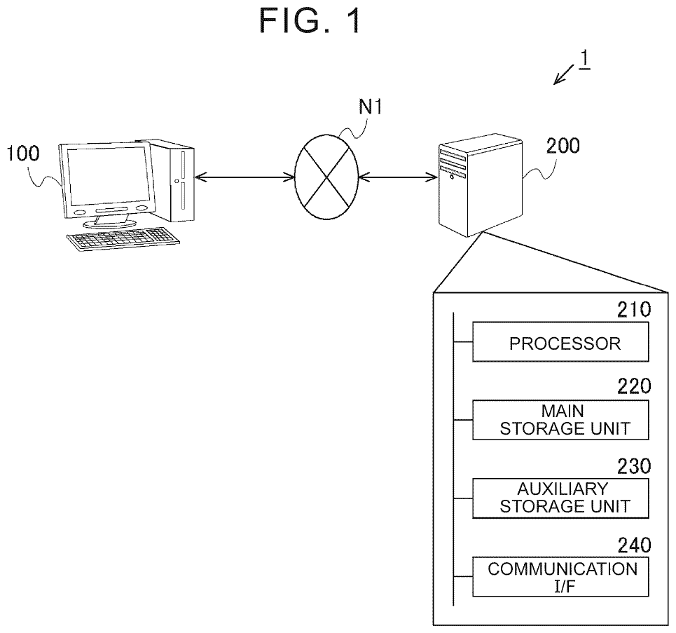

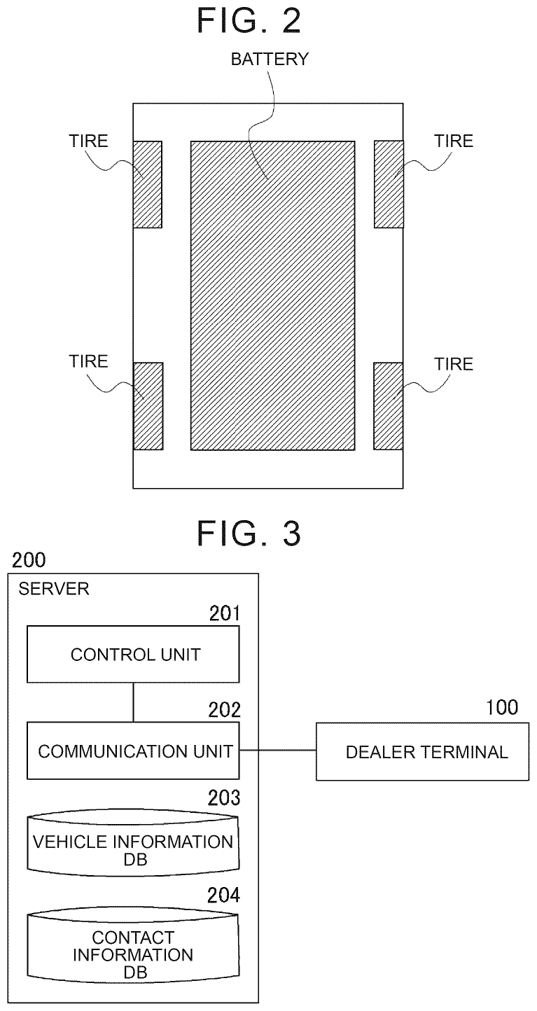

The storage system 1 according to the present embodiment will be described with reference to FIGS. 1 and 2. FIG. 1 is a diagram illustrating a schematic configuration of a storage system 1. The storage system 1 includes a dealer terminal 100 and a server 200. In the storage system 1, the dealer terminal 100 and the server 200 are connected to each other via a network N1. The network N1 may be, for example, a worldwide public communication network such as Internet or the like, and a wide area network (WAN) or a telecommunications network such as a cellular network.

### Dealer Terminal

The dealer terminal 100 is a terminal used by a dealer of a vehicle (hereinafter, may be simply referred to as a “dealer”). The dealer terminal 100 is, for example, a computer or a personal digital assistant used by the dealer.

The dealer removes a battery (hereinafter, sometimes simply referred to as a “battery”) attached to the vehicle. Then, the dealer stores the removed battery. The stored battery is then collected and the rebuild process performed. Here, the battery is a battery for driving a motor such as a battery type battery electric vehicle or a hybrid-type battery electric vehicle. The battery may be a battery used for an auxiliary battery or the like in a vehicle.

Here, the rebuild process is a process used for rebuild in which part or all of the components are reused. The rebuild process is a process in which a battery is disassembled into a component and a reusable component is reused as a battery for another vehicle. Here, the component of the battery is, for example, a cell constituting the battery. Further, the components of the battery may be, for example, a module or a substrate constituting the battery. In such a case, the parts removed from the battery are reused as parts of the newly manufactured battery. In the rebuild process, the battery may be used as it is by re-assembling it as a battery for another vehicle without disassembling the battery. It should be noted that the battery that is not subjected to the rebuild process is subjected to a recycling process to be reused as a resource or a process to be discarded.

The dealer terminal 100 transmits the information to the server 200 via the network N1. Here, the vehicle information is information about the vehicle to which the battery stored in the dealer is attached. The vehicle information includes information on the presence or absence of an accident history of the vehicle to which the battery is attached. In the vehicle information, when there is an accident history in the vehicle, information on the situation of the accident of the vehicle having the accident history (hereinafter, sometimes referred to as “accident vehicle”) is included.

In the present embodiment, the vehicle information includes information about the collision speed, the collision location, and the collision direction of the accident vehicle at the time of occurrence of the accident (hereinafter, may be referred to as “accident information”) as information indicating the degree of collision in the accident. Further, the vehicle information includes information on charging and discharging of the battery after the accident of the accident vehicle (hereinafter, may be referred to as “charging and discharging information”). The charge and discharge information is, for example, information about the transition of charge and discharge of the battery (transition of the charge amount) after the occurrence of the accident. Further, the charge and discharge information may be, for example, information indicating whether or not the battery normally performs charging and discharging after the occurrence of an accident.

Here, the dealer terminal 100 can be connected to a vehicle. For example, the dealer terminal 100 acquires the presence or absence of an accident history of the vehicle by analyzing an impact sensed by a sensor mounted on the vehicle. In addition, the dealer terminal 100 identifies the collision speed by acquiring the speed at the time of collision and the acceleration (impact) caused by the collision from, for example, an ECU (electronic control unit) that controls the travel mounted on the accident vehicle. Further, the dealer terminal 100 may identify the collision speed by analyzing the moving image at the time of collision acquired from the camera mounted on the vehicle.

Further, the dealer terminal 100 acquires the collision location of the accident vehicle by, for example, receiving the input of the position of the collision mark confirmed by the dealer. In addition, the dealer terminal 100 may identify a collision location of the accident vehicle by analyzing a moving image at the time of collision acquired from, for example, a camera mounted on the vehicle. In addition, the dealer terminal 100 may identify a collision point of the accident vehicle by referring to a manner of applying acceleration (a manner of receiving impact) at the time of the accident of the accident vehicle.

In addition, the dealer terminal 100 calculates the collision direction of the accident vehicle from, for example, a change in acceleration at the time of a collision sensed by an acceleration sensor mounted on the vehicle. Further, the dealer terminal 100 may specify the collision direction of the accident vehicle by analyzing a moving image at the time of collision acquired from, for example, a camera mounted on the vehicle. In addition, the dealer terminal 100 acquires charge and discharge data from an ECU that measures the state of charge and discharge of the accident vehicle.

Note that the dealer terminal 100 may transmit, as the accident information, information such as the speed and acceleration sensed by the sensors or a moving image captured by the camera to the server 200. In this case, the server 200 identifies the collision speed, the collision location, and the collision direction with reference to the received information. In addition, the dealer terminal 100 may transmit the collision speed, the collision location, and the collision direction of the accident vehicle input by the dealer to the dealer terminal 100 to the server 200.

### Server

The server 200 is a server device that manages collection of batteries stored by a dealer. The server 200 receives the information from the dealer terminal 100 via the network N1. Here, a battery installed in a vehicle having an accident history may be damaged due to the influence of an accident. As a result, the battery may not be able to be used for a rebuild that reuses some or all of the components due to damage. It is also envisioned that the use of such a damaged battery for rebuilding may cause a failure of a new battery with a failed component attached thereto. On the other hand, if all of the batteries of the accident vehicle are not used for rebuilding, efficient reuse of the batteries is suppressed.

FIG. 2 is a diagram illustrating an example of the arrangement of batteries in a vehicle. In the example shown in FIG. 2, a battery is attached to the lower portion of the vehicle body. At this time, it is assumed that the accident vehicle has caused a collision at a certain collision speed. In addition, it is assumed that the accident vehicle collides with the front portion of the vehicle from the front. Then, it is assumed that the front part of the battery is damaged. In the present embodiment, damage to the battery means, for example, damage to a plurality of cells provided in the battery. That is, damage to the front portion of the battery means that the cells provided in the front portion of the battery are damaged. It is also envisioned that the extent of damage will vary depending on the impact speed.

Further, it is assumed that the accident vehicle collides with the side surface portion of the vehicle from an oblique direction. Then, it is assumed that a certain range of the side surface portion of the battery in the oblique direction from the collision point is damaged. As described above, the portion where the battery may be damaged is different depending on the collision speed, the collision location, and the collision direction of the accident vehicle.

On the other hand, it is envisaged that the cells of the undamaged part of the accident vehicle can be used for rebuilding. Therefore, the server 200 uses the vehicle information received from the dealer terminal 100 to identify a portion that can be used for rebuilding the battery attached to the accident vehicle (hereinafter, may be referred to as a “rebuildable portion”). Then, the server 200 transmits the result-information indicating the identified rebuildable part to the dealer terminal 100 through the network N1. Details of how the server 200 identifies the rebuildable portion of the battery attached to the accident vehicle will be described later.

In the present embodiment, the server 200 identifies a cell that can be used for rebuilding. However, the server 200 may identify a component other than the cell of the battery as a rebuildable portion. In addition, the server 200 may identify a battery that can be used for rebuilding from a plurality of batteries attached to the vehicle as a rebuildable portion.

The server 200 includes a computer having a processor 210, a main storage unit 220, an auxiliary storage unit 230, and a communication interface (communication I/F) 240. The processor 210 is, for example, a central processing unit (CPU) or a digital signal processor (DSP). The main storage unit 220 is, for example, a random access memory (RAM). The auxiliary storage unit 230 is, for example, a read only memory (ROM). The auxiliary storage unit 230 is, for example, a hard disk drive (HDD) or a disc recording medium such as a CD-ROM, a DVD disc, or a Blu-ray disc. The auxiliary storage unit 230 may be a removable medium (a portable storage medium). Examples of the removable medium include a USB memory or an SD card. The communication I/F 240 is, for example, a local area network (LAN) interface board or wireless communication circuitry for wireless communication.

In the server 200, an operating system (OS), various programs, various information tables, and the like are stored in the auxiliary storage unit 230. Further, in the server 200, the processor 210 loads the program stored in the auxiliary storage unit 230 into the main storage unit 220 and executes the program, thereby realizing various functions as described later. However, some or all of the functions of the server 200 may be implemented by hardware circuitry such as ASIC or FPGA. Note that the server 200 does not necessarily have to be realized by a single physical configuration, and may be constituted by a plurality of computers that cooperate with each other. The dealer terminal 100 includes a computer as in the case of the server 200.

### Functional Configuration

Next, the functional configuration of the server 200 constituting the storage system 1 will be described with reference to FIG. 3 to FIG. 5. FIG. 3 is a block diagram schematically illustrating an example of a functional configuration of the server 200. The server 200 includes a control unit 201, a communication unit 202, a vehicle information database 203 (vehicle information DB 203), and a correspondence information database 204 (correspondence information DB 204).

The control unit 201 has a function of performing arithmetic processing for controlling the server 200. The control unit 201 can be realized by the processor 210 in the server 200. The communication unit 202 has a function of connecting the server 200 to a network N1. The communication unit 202 can be realized by a communication I/F 240 in the server 200.

The vehicle information DB 203 has a function of storing vehicle information. The vehicle information DB 203 can be realized by the auxiliary storage unit 230 in the server 200. The control unit 201 receives vehicle information from the dealer terminal 100 via the communication unit 202. The control unit 201 stores the received vehicle information in the vehicle information DB 203.

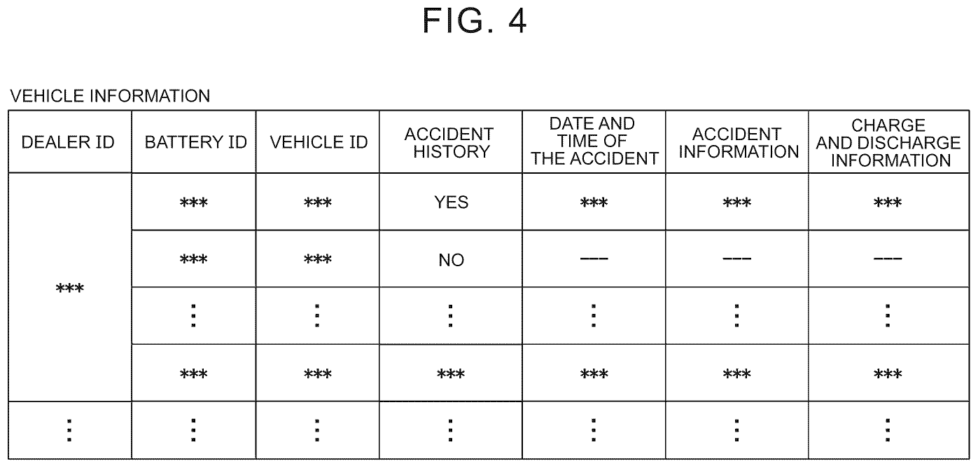

FIG. 4 is a diagram illustrating an exemplary table configuration of vehicle information stored in the vehicle information DB 203. The vehicle information includes a dealer ID field, a battery ID field, a vehicle ID field, an accident history field, an accident date and time field, an accident information field, and a charge and discharge information field.

In the dealer ID field, an identifier (dealer ID) for identifying the dealer storing the batteries is stored. In the battery ID field, an identifier (battery ID) for identifying a battery stored in a dealer of the corresponding dealer ID is stored. In the vehicle ID field, an identifier (vehicle ID) for identifying the vehicle to which the batteries are attached is stored.

In the accident history field, information indicating the presence or absence of the accident history of the vehicle in the corresponding vehicle ID field is stored. In the example illustrated in FIG. 4, when there is an accident history in the vehicle, information indicating “Yes” is stored. In the example illustrated in FIG. 4, information indicating “none” is stored when there is no accident history in the vehicle. In the accident date and time field, information indicating the date and time when the vehicle having the accident history has caused the accident is stored.

In the accident information field, information indicating a collision speed, a collision location, and a collision direction when a vehicle having an accident history (an accident vehicle) causes an accident is stored as accident information. In the charge and discharge information field, information on charge and discharge of the battery after the accident of the accident vehicle is stored as charge and discharge information. When the vehicle of the corresponding vehicle ID is a vehicle having no accident history, information is not stored in the accident date and time field, the accident information field, and the charge and discharge information field.

By acquiring the vehicle information from the vehicle information DB 203, the control unit 201 can grasp whether or not the vehicle to which the batteries stored in the dealer are attached is an accident vehicle. In addition, the control unit 201 can grasp the accident information by acquiring the vehicle information from the vehicle information DB 203. Further, the control unit 201 can grasp the charge and discharge information by acquiring the vehicle information from the vehicle information DB 203.

The control unit 201 refers to the accident information in the vehicle information, and identifies a rebuildable portion of a battery (hereinafter, sometimes referred to as a “specific battery”) attached to the accident vehicle. Specifically, the control unit 201 refers to the accident information and the correspondence information held in the correspondence information DB 204, and identifies the rebuildable part of the specified batteries. Here, the correspondence information is information indicating a correspondence relationship between the position where the collision occurred, the direction in which the collision occurred, and the collision speed, and the rebuildable portion.

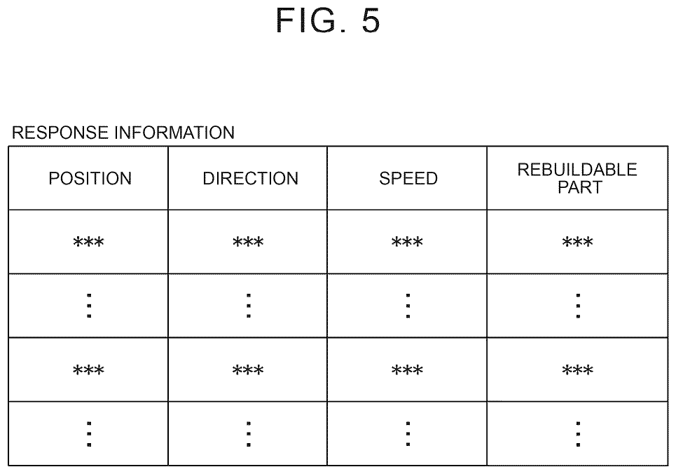

The correspondence information DB 204 has a function of holding correspondence information. The correspondence information DB 204 can be realized by the auxiliary storage unit 230 in the server 200. FIG. 5 is a diagram illustrating an exemplary table configuration of the correspondence information held in the correspondence information DB 204. Corresponding information has a location field, an orientation field, a velocity field, and a rebuildable portion field.

In the position field, position information indicating each position in the vehicle is stored. In the direction field, direction information indicating a direction based on a predetermined direction of the vehicle is stored. Here, the predetermined direction is, for example, a forward direction of the vehicle. In this case, the direction field stores direction information indicating the direction with respect to the forward direction of the vehicle. In the velocity field, information indicating the velocity is stored.

In the rebuildable partial field, cell information indicating a cell of a specific battery that can be used for rebuilding is stored at a position indicated by the position information in a case where the vehicle causes a collision accident at a collision speed indicated by the speed information from a direction indicated by the direction information. The cell information includes, for example, an identifier (cell ID) for identifying one or a plurality of cells that can be used for rebuilding. When all the cells of the specific battery are usable, the cell data including the cell ID of all the cells of the specific battery is stored.

Here, the cell ID in the cell info stored in the available sub-field is determined, for example, by collision simulations. In this case, the control unit 201 uses the simulation model of the vehicle to analyze the damaged state of the battery in a case where the vehicle collides at each speed from each direction at each position. The control unit 201 identifies, as a rebuildable portion, a cell that can be determined to be usable for rebuild in accordance with the analyzed damaged state of the battery. Then, the control unit 201 generates a cell ID for the identified cell as cell information, and stores the cell information in the correspondence information. In this way, the control unit 201 can specify the cell of the specific battery that can be used for the rebuild in the case where the vehicle causes a collision accident at the speed indicated by the speed information from the direction indicated by the direction information at the position indicated by the position information.

Further, the cell information may be generated by, for example, aggregating a correspondence relationship between a situation of a plurality of collision accidents that have occurred in the past (collision speed, collision location, and collision direction) and a cell of a battery that has actually been used for rebuilding the battery after the plurality of collision accidents.

The control unit 201 refers to the correspondence information and specifies a record in which the speed information, the position information, and the direction information corresponding to the collision speed, the collision location, and the collision direction in the accident information are stored. Note that the control unit 201 specifies a record having an approximate value when there is no speed information, position information, or direction information corresponding to the collision speed, the collision location, or the collision direction in the accident information. The control unit 201 acquires the cell information stored in the usable partial field included in the specified record. Then, the control unit 201 identifies a cell of one or a plurality of cell ID included in the cell data as a rebuildable part.

In addition, when the specific battery is normally charged and discharged, it is assumed that the specific battery is not damaged. In this case, it is assumed that all of the specific batteries can be used for rebuilding. In other words, it is assumed that the specific battery may be used for rebuild in which the specific battery is reassembled if the change in charge and discharge (change in charge amount) of the battery after the occurrence of the accident indicated by the charge and discharge information is normal. In addition, if the charge and discharge information include information indicating that the specific battery is normally charged and discharged after the occurrence of the accident, it is assumed that the specific battery may be used for rebuilding to be reassembled.

Therefore, the control unit 201 refers to the charge and discharge information in the vehicle information held in the vehicle information DB 203, and determines whether or not to execute a process of specifying a part that can be used for rebuilding the specific battery. As a result, it is possible to suppress at least a part (a part of cells) of the specific battery becoming unusable for the rebuild.

The control unit 201 generates result information via the communication unit 202, and outputs (transmits) the result information to the dealer terminal 100. Here, the result information includes information indicating a rebuildable portion. That is, the resulting information includes information indicating a cell ID that is a rebuildable part. When all the cells of the specific battery are usable, the result information may include information indicating that the specific battery may be used as it is. When the server 200 outputs the result information to the dealer terminal 100, the dealer can grasp a portion where the specific battery can be used for rebuilding.

### Flowchart

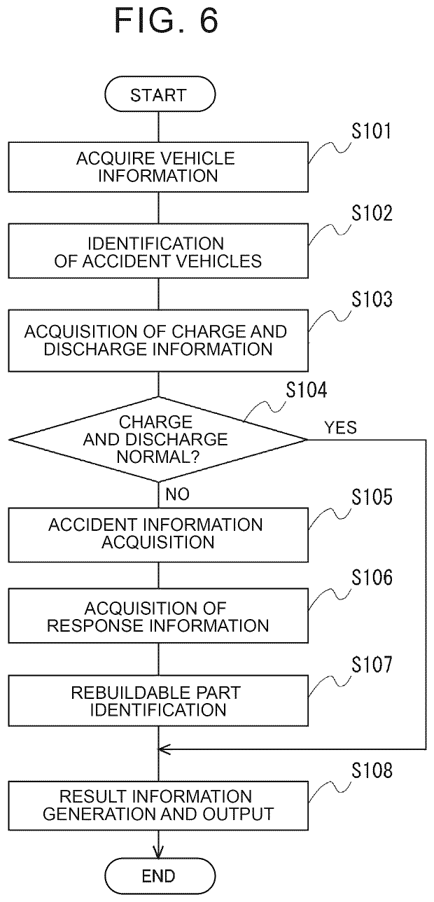

Next, processing executed by the control unit 201 in the server 200 will be described with reference to FIG. 6. FIG. 6 is a flowchart of processing executed by the control unit 201. The process is a process of identifying a rebuildable portion of the specific battery. The execution of the processing is started at a predetermined timing. The predetermined timing is, for example, a timing at which the dealer instructs the server 200 to execute the process using the dealer terminal 100. The predetermined timing may be a periodic timing.

In the process illustrated in FIG. 6, first, vehicle information is acquired from the vehicle information DB 203 in S101. Next, in S102, the vehicle data is referenced and the accident vehicle is identified. Specifically, the control unit 201 identifies, as an accident vehicle, a vehicle having a vehicle ID in which the accident history is “present” in the accident history field in the vehicle information. Next, in S103, charge and discharge information about the identified accident vehicle is obtained from the charge information field of the vehicle information. Next, in S104, it is determined whether or not the specified batteries are normally charged and discharged after the accidental occurrence.

If an affirmative determination is made in S104, it is assumed that the particular cell can be used as it is for rebuild. Therefore, in S107, the dealer terminal 100 receives the information indicating that the specific-battery may be used for rebuilding the specific-battery to the other vehicles. Then, the processing illustrated in FIG. 6 is ended.

On the other hand, when a negative determination is made in S104, the accident information is acquired from the vehicle information in S105. Further, in S106, the correspondence information is acquired from the correspondence information DB 204. Next, in S107, the accident information and the correspondence information are referred to, and the rebuildable part is identified. Next, in S108, the resulting data indicating the identified rebuildable part is generated and outputted to the dealer terminal 100. Then, the processing illustrated in FIG. 6 is ended.

As described above, the storage system 1 identifies the rebuildable portion. As a result, a portion that can be used for rebuilding is used for rebuilding even for a specific battery that has been attached to an accident vehicle. In this way, efficient reuse of the battery can be achieved.

### First Modification

In the present embodiment, the server 200 specifies the rebuildable portion of the specific battery by using the collision speed, the collision location, and the collision direction in the vehicle information (accident information). However, the server 200 may refer to at least one of the collision speed and the collision location to identify the rebuildable portion of the specific battery. In addition, the server 200 may identify the rebuildable portion of the specific battery by referring to the collision location and the collision direction.

The server 200 may identify the rebuildable portion according to the collision speed. In this case, for example, when the collision speed is equal to or lower than the predetermined speed, the server 200 may identify the entire specific battery as a rebuildable portion.

In addition, the server 200 may identify the rebuildable portion according to the collision location. In this case, for example, when the right side surface of the vehicle is a collision location, the server 200 determines that a cell in a predetermined range is damaged from the right side surface, and identifies a cell outside the predetermined range as a rebuildable portion. Here, the predetermined range is predetermined as a range in which a cell is assumed to be damaged when a collision occurs at a collision location. The server may also identify the rebuildable portion according to the collision speed and the collision location. In this case, a predetermined range is predetermined in accordance with the collision speed. Then, the server 200 identifies, from the collision location, the outside of a predetermined range determined in advance in accordance with the collision speed as a rebuildable portion.

In addition, the server 200 may identify the rebuildable portion according to the collision location and the collision direction. In this case, the outside of the predetermined range in the collision direction from the collision location is specified as the rebuildable portion. Here, the predetermined range is determined in advance as a range in which the cell is assumed to be damaged in a case where a collision in the collision direction occurs at the collision point. Even if the rebuildable portion is identified in this manner, the battery can be efficiently reused.

### Second Modification

In the present embodiment, the accident vehicle is a vehicle that has caused a collision accident. On the other hand, when the vehicle is submerged in water, the battery may be damaged due to water immersion. Then, it may be damaged by the effect of flooding. Therefore, in the present modification, the server 200 identifies the rebuildable portion of the vehicle in which the submergence accident has occurred as the accident vehicle.

Here, it is assumed that the inundation location is different depending on the water level at the time of submergence. Therefore, it is assumed that the rebuildable portion differs depending on the water level at the time of submergence. Therefore, in the present modification, the server 200 acquires information indicating the water level when the accident vehicle is submerged as the accident information. The accident information is generated by the dealer inputting the water level at the time of submergence to the dealer terminal 100. Further, the accident information may be generated by the dealer terminal 100 acquiring a water level at the time of submergence from a sensor that detects submergence of the vehicle.

The server 200 acquires, as correspondence information, information indicating a correspondence relationship between the water level at the time of submergence and the rebuildable portion. Here, the correspondence information is generated by performing simulation analysis on the inundation location at each water level. Further, the correspondence information may be generated by aggregating the correspondence relationships between the water levels of the plurality of water submergence accidents that have occurred in the past and the cells of the battery that have actually been used for rebuilding after the plurality of water submergence accidents.

Then, the server 200 refers to the water level at the time of submergence in the accident information and the correspondence information, and identifies the rebuildable portion. Even in this manner, the battery can be efficiently reused.

Further, the server 200 may acquire information about the collision speed, the collision point, and the collision direction, as well as the water level at the time of submergence, as accident information, and identify the rebuildable portion. In this case, the server 200 identifies, as a rebuildable portion, a common portion between the rebuildable portion in the correspondence information regarding the collision speed, the collision location, and the collision direction and the rebuildable portion in the correspondence information regarding the water level at the time of submergence.

### Third Modification

In the present embodiment, the accident vehicle is a vehicle that has caused a collision accident. On the other hand, it is assumed that an accident in which a vehicle burns due to a fire or the like (hereinafter, sometimes referred to as a “fire accident”) has occurred. In this case, the battery may be damaged by the effect of a fire. This may result in a portion that cannot be used for rebuilding due to a fire in the event of a fire. Therefore, in the present modification example, the server 200 identifies the rebuildable portion of the vehicle in which the fire accident has occurred as the accident vehicle.

The server 200 acquires, as the accident information, information indicating a portion affected by a fire in the accident vehicle. Here, the accident information is generated by inputting, to the dealer terminal 100, a portion (for example, a portion where there is a sign of burning) where the dealer has received a fire in the accident vehicle. Here, for example, the dealer confirms the inside of the vehicle or the inside of the battery, and settles the portion subjected to the fire into the dealer terminal 100 as a portion affected by the fire. In addition, the dealer may input a portion of the surface of the vehicle that has been subjected to a fire to the dealer terminal 100 as a portion that is affected by the fire.

Then, the server 200 acquires, as correspondence information, information indicating a correspondence relationship between the portion affected by the fire and the rebuildable portion. Here, the correspondence information is generated by aggregating a correspondence relationship between a portion affected by a fire in a plurality of fire accidents that have occurred in the past and a cell of a battery that can be actually used for rebuilding after the plurality of fire accidents. Then, the server 200 refers to the portion affected by the fire in the accident information and the correspondence information, and identifies the rebuildable portion. Note that the server 200 may identify a portion outside the predetermined range from the portion affected by the fire as a rebuildable portion. Here, the predetermined range is, for example, a range in which the influence of the fire is assumed to be exerted from a place where the fire is received on the surface of the vehicle. Even in this manner, the battery can be efficiently reused.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Examples of the non-transitory computer-readable storage medium include any type of media suitable for storing electronic instructions, such as, any type of disk, such as a magnetic disk (a floppy (registered trademark) disk, a hard disk drive (HDD), and the like) or an optical disc (such as a CD-ROM, a DVD disc, and a Blu-ray disc), a read only memory (ROM), a random access memory (RAM), an EPROM, an EEPROM, a magnetic card, a flash memory, or an optical card.

What is claimed is:

1. An information processing device comprising a control unit configured to
acquire accident information related to a status of an accident of an accident vehicle,
identify a portion of a battery attached to the accident vehicle that is usable in a rebuild in which some or all parts of the battery are reused, using the acquired accident information, and
output information about the identified portion of the battery that is usable in the rebuild.

2. The information processing device according to claim 1, wherein:
the accident vehicle is a vehicle that has caused a collision accident;
the accident information includes information indicating a degree of collision of the accident vehicle at a time of occurrence of the accident; and
the identifying of a portion of the battery that is usable in the rebuild includes identifying a portion of the battery that is usable in the rebuild according to the degree of collision.

3. The information processing device according to claim 1, wherein:
the accident vehicle is a vehicle that has caused a submergence accident;
the accident information includes information indicating a water level at a time of submergence of the accident vehicle at a time of occurrence of the accident; and
the identifying of a portion of the battery that is usable in the rebuild includes identifying a portion of the battery that is usable in the rebuild according to the water level.

4. The information processing device according to claim 1, wherein:
the accident vehicle is a vehicle that has caused a fire accident;
the accident information includes information indicating a portion of the accident vehicle affected by a fire; and
the identifying of a portion of the battery that is usable in the rebuild includes identifying a portion of the battery that is usable in the rebuild according to the portion of the accident vehicle affected by the fire.

5. The information processing device according to claim 1, wherein the control unit is further configured to
acquire charge and discharge information about charge and discharge of the battery after the accident of the accident vehicle, and
determine whether to execute a process of identifying a portion of the battery that is usable in the rebuild, using the charge and discharge information.
